(19) United States
(12) Patent Application Publication
(10) Pub. No.: US 2020/0162926 A1
(43) Pub. Date: May 21, 2020

(54) Detection And Prevention Of Broadcast And Multicast Packet Attacking For Uncovering And Disconnecting Attackers In Wireless Communications

(71) Applicant: MediaTek Inc., Hsinchu City (TW)

(72) Inventor: Ming-Wang Guo, Hsinchu City (TW)

(21) Appl. No.: 16/192,778

(22) Filed: Nov. 15, 2018

(51) Int. Cl. H04W 12/12; H04W 12/04; H04W 12/00

(52) U.S. Cl. CPC H04W 12/1204; H04L 63/1441; H04W 12/001; H04W 12/04033

(57) ABSTRACT

Techniques and examples pertaining to detection and prevention of broadcast and multicast packet attacking and uncovering to disconnect attackers in CCMP or TKIP-enabled wireless communications are described. A processor of a first network device establishes a wireless communication with a second network device in a wireless network. The processor detects a broadcast or multicast attack in the wireless network. The processor then notifies the second network device of the attack with a pairwise key encrypted frame.

### TECHNICAL FIELD

The present disclosure is generally related to wireless communications and, more particularly, to detection and prevention of broadcast and multicast packet attacking for uncovering and disconnecting attacker(s) in wireless communications.

### BACKGROUND

Unless otherwise indicated herein, approaches described in this section are not prior art to the claims listed below and are not admitted as prior art by inclusion in this section.

For secure communication in wireless communication systems such as Wi-Fi networks according to the Institute of Electrical and Electronics Engineers (IEEE) 802.11 specification(s), one or more encryption methods may be utilized, including Wired Equivalent Privacy (WEP), Temporal Key Integrity Protocol (TKIP), Advanced Encryption Standard (AES) and Protected Management Frames (PMF). For broadcast (BC) and multicast (MC) data frames, a common key (e.g., group key) can be shared by an access point (AP) and stations (STAs) that are wirelessly connected to the AP, and devices in the basic service set (BSS) associated with the AP are capable of encryption and decryption of broadcast packets. Normally, STAs associated with an AP need to decrypt BC and MC frames when receiving BC and MC frames from the AP, and only the AP would send BC and MC frames to the STAs as this is typically the usage of infrastructure BSS. Thus, any device may be capable of attacking other devices in the same BSS. An attacking device may attack a Wi-Fi BSS by transmitting BC and/or MC frames to cause STAs in the BSS to treat such BC/MC frames as if they were transmitted by the AP.

Nevertheless, presently there is no consideration in current IEEE 802.11 standard that the attacking may be from one of the devices within the BSS so as to prevent such an issue. Specifically, in section 11.4.3.4.4 of the IEEE 802.11 standard, it is stated that “[t]he receiver shall discard MSDUs, A-MSDUs, and MMPDUs whose constituent MPDU PN values are not sequential” and “[a] receiver shall discard any MPDU that is received with its PN less than or equal to the replay counter.” However, the standard currently does not address how to prevent BC/MC attacks with replay counter. Additionally, there is no consideration in the standard that the original BC/MC packets may be discarded at receiving STAs, and there is also no consideration for any side effect of this kind of attacks.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

Under various proposed techniques, methods, schemes and/or solutions in accordance with the present disclosure, broadcast (BC) and multicast (MC) attacking may be detected by a STA or an AP in an AES or TKIP-enabled IEEE 802.11 network. Additionally, the AP may use group key rekey negotiation or replay counter renew process to prevent BC/MC attacking from an unknown device. Moreover, the AP may, based on group key rekey negotiation, uncover which STA may be the attacker that is conducting BC/MC attacks in the BSS.

In one aspect, a method may involve a processor of a first network device establishing a wireless communication with a second network device in a wireless network. The method may also involve the processor detecting a broadcast or multicast attack in the wireless network. The method may further involve the processor notifying the second network device of the attack with a pairwise key encrypted frame.

In one aspect, an apparatus may include a transceiver and a processor coupled to the transceiver. The transceiver may be capable of establishing, as a first network device, a wireless communication with a second network device in a wireless network. The processor may be capable of detecting a broadcast or multicast attack in the wireless network. The processor may also be capable of notifying the second network device of the attack with a pairwise key encrypted frame.

It is noteworthy that, although description provided herein may be in the context of certain radio access technologies, networks and network topologies such as IEEE 802.11, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, 5^{th}-Generation (5G), New Radio (NR) and Internet-of-Things (IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various examples in accordance with the present disclosure may be implemented.

FIG. 2 is a block diagram of an example system in accordance with an implementation of the present disclosure.

FIG. 3 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to detection and prevention of broadcast and multicast packet attacking and uncovering to disconnect attackers in Counter Mode Cipher Block Chaining Message Authentication Protocol (CCMP) or TKIP-enabled wireless communications. That is, under a proposed scheme in accordance with the present disclosure, attacks may be detected and prevented, and a device which is the attacker in a BSS domain may be uncovered. The proposed scheme may be implemented on the AP side by the AP associated with a BSS as well as on the STA side by each STA in the BSS, as described below.

Under the proposed scheme, on the STA side, in an event that a number of BC/MC frames are received with replay detection from another STA (e.g., an attacking device) in a BSS, a receiving STA may consider this as an indication of BC/MC attack. The attacking device may be connected to a common AP and may fake BC/MC frames with a transmit (TX) address identical to that of the media access control (MAC) address of the AP. Accordingly, the receiving STA may notify the AP, for example, by a unicast frame with pairwise key encryption. Additionally, under the proposed scheme, each STA in the BSS may communicate with the AP and other STA(s) using encryption in an AES-enabled mode or a TKIP-enabled mode. Normally, under the BSS structure, AP and each STA can communicate with each other directly, while two STAs communicate with each other indirectly through the AP (e.g., STA 1 can communicate to STA 2 by STA 1 transmitting frame(s) to AP which in turn forward the frame(s) to STA 2). Moreover, each STA may diagnose reply detection and become aware of a BC/MC attack in the BSS. For instance, with a number of attacking packets detected from a specific STA within a given period, a STA may send a specific frame to the AP to notify the AP of the BC/MC attack. In some cases, the STA may use a unicast packet with pairwise key encryption to notify the AP.

Under the proposed scheme, on the AP side, an AP of a BSS may receive a BC/MC frame with COMP or TKIP encryption enabled, and a basic service set identifier (BSSID) indicated in each BC/MC frame may be equal to a MAC address of the AP. Accordingly, the AP may detect BC/MC attacks for the BSS, for example, by checking and verifying whether a packet number (PN) of an AES frame or a TKIP sequence counter (TSC) of a TKIP frame is greater than a current replay counter. For AES, it takes PN0, PN1, PN2, PN3, PN4 and PN5 to detect replay counter. For TKIP, it takes TSC0, TSC1, TSC2, TSC3, TSC4 and TSC5 to detect replay counter. Once the AP becomes aware that the BC/MC frame is used for a BC/MC attack, the AP may carry out one or more actions to prevent any further attack in the BSS. For instance, the AP may trigger a group key rekey negotiation for all STAs associated with the BSS. Alternatively, or additionally, the AP may trigger a replay counter renew process between the AP and each STA associated with the BSS. Alternatively, or additionally, the AP may transmit a notification frame to a network manager to indicate that the BSS is under BC/MC attack.

Moreover, under the proposed scheme, once the AP becomes aware that the BC/MC frame is used for a BC/MC attack, the AP may perform group key rekey negotiation with one or more of the STAs in the BSS as a way to identify or otherwise determine which one(s) of the STAs in the BSS may be the attacking device(s) that initiated the BC/MC attack by using BC/MC packets to attack the BSS. Once the AP identifies which one(s) of the STAs associated with the BSS is/are the attacking device(s), the AP may disconnect such attacking STA(s) from the BSS as well as to reject such attacking STA(s) from the BSS.

Under the proposed scheme, the AP may communicate with STAs in the BSS using encryption in an AES-enabled mode or a TKIP-enabled mode. Accordingly, the AP may receive BC/MC frames with BSSID that is equal to the MAC address of the AP. In an event that the AP receives a number of BC/MC frames within a given period, the AP may detect or otherwise determine that there is BC/MC attack in the BSS when each of such BC/MC frames indicates a BSSID equal to the MAC address of the AP with the PN (in AES-enabled mode) or TSC (in TKIP-enabled mode) being greater than a current replay counter.

Thus, the AP may become aware of existence or occurrence of a BC/MC attack in the BSS either by receiving a notification from a STA in the BSS or by the AP itself detecting such BC/MC attack. In an event that there is a single STA connected to the AP, the AP may start a group key rekey negotiation with the STA. This is because the attacking device is not one of the devices in the BSS (namely, the AP and the single STA), and the rekey may prevent further attack. In an event that there are two or more STAs connected to the AP, the AP may start a group key rekey negotiation for all STAs so as to change the group key to prevent further attack. Alternatively, the AP may start a replay counter renew process for all STAs so as to prevent further attacked, as the attacking device may be one of the STAs in the BSS.

Under the proposed scheme, the AP may intentionally perform a group key rekey negotiation to some, but not all, of the STAs associated with the BSS to uncover which device(s) among the STAs may be the attacking device(s) that initiated or otherwise carried out the attack in the BSS. Once the attacking device(s) is/are identified or otherwise determined, the AP may disconnect such attacking device(s) from the BSS as well as reject such attacking device(s) from the BSS. The AP may transmit a specific frame to a network manager to indicate replay detection and/or that attacking device(s) has/have been found. The AP may also record or otherwise store identification of each attacking device (e.g., in a blacklist).

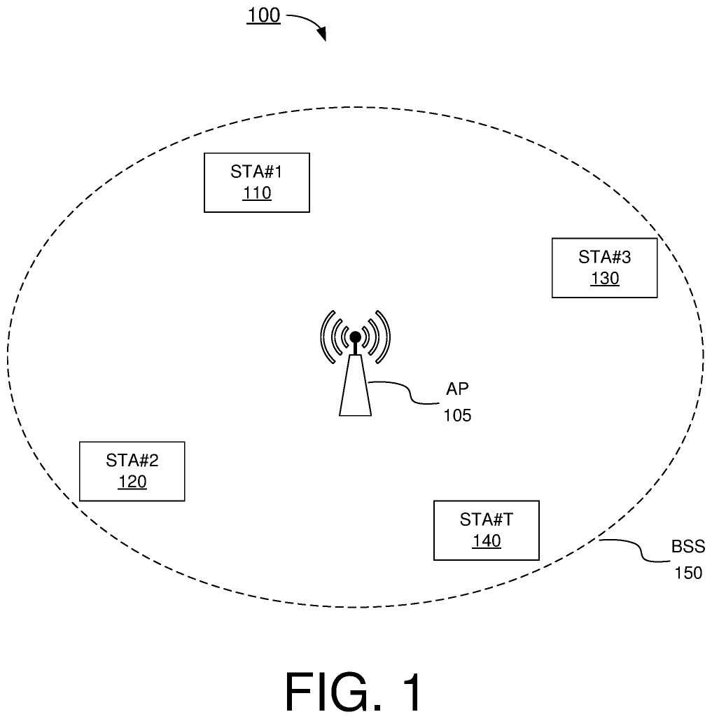

FIG. 1 illustrates an example network environment 100 in which various examples in accordance with the present disclosure may be implemented. Network environment 100 may involve an AP 105 hosting a BSS 150 with a number of STAs associated with BSS 150. In the example shown in FIG. 1, STA #1, STA #2 120 and STA #3 130 may be in or otherwise associated with BSS 150. As a non-limiting and illustrative example, once AP 105 becomes aware of a BC/MC attack, AP 105 may perform a group key rekey negotiation with STA #1 110 and STA #2 120, but not with STA #3 130. Subsequently, in an event that the same kind of attacking continues, AP 105 may diagnose or otherwise determine that the attack is from either STA #1 110 or STA #2 120 and that STA #3 130 is not the attacking device. Further, AP 105 may perform a group key rekey negotiation with STA #1 110 and STA #3 130, but not with STA #2 120. In an event that the same kind of attacking still continues, AP 105 may uncover, identify or otherwise determine that STA #1 110 is the attacking device.

As another non-limiting and illustrative example, AP 105 may add a trusted STA (e.g., STA # T 140) to BSS 150 and perform a first round of partial group key rekey negotiation with STA # T 140 and STA #1. Then, the AP may perform a second round of partial group key rekey negotiation with STA # T 140 and STA #2 120. This method may be continued by the AP (e.g., performing a third round of partial group key rekey negotiation with STA # T 140 and STA #3 130) until the attacking device(s) is/are uncovered.

### Illustrative Implementations

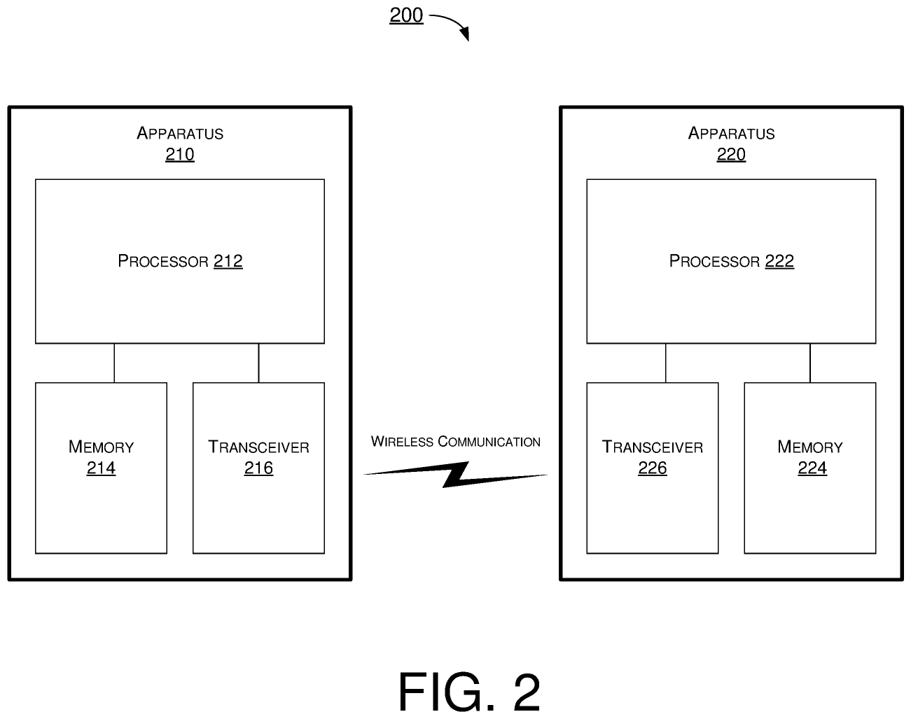

FIG. 2 illustrates an example system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to detection and prevention of broadcast and multicast packet attacking for uncovering and disconnecting attacker(s) in wireless communications, including the various schemes described above with respect to various proposed designs, concepts, schemes, systems and methods described above as well as process 300 described below. That is, each of apparatus 210 and apparatus 220 may be an example implementation of AP 105 or one of STA #1, STA #2 120, STA #3 130 and STA # T 140 in network environment 100.

Each of apparatus 210 and apparatus 220 may be a part of an electronic apparatus, which may be a network apparatus or a STA, such as a portable or mobile apparatus, a wearable apparatus, a wireless communication apparatus or a computing apparatus. For instance, each of apparatus 210 and apparatus 220 may be implemented in a smartphone, a smart watch, a personal digital assistant, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an AP in a Wi-Fi network. Alternatively, apparatus 210 and/or apparatus 220 may be implemented in an eNodeB in an LTE, LTE-Advanced or LTE-Advanced Pro network or in a gNB or TRP in a 5G network, an NR network or an IoT network.

In some implementations, each of apparatus 210 and apparatus 220 may be implemented in the form of one or more integrated-circuit (IC) chips such as, for example and without limitation, one or more single-core processors, one or more multi-core processors, or one or more complex-instruction-set-computing (CISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including those pertaining to detection and prevention of broadcast and multicast packet attacking for uncovering and disconnecting attacker(s) in wireless communications in accordance with various implementations of the present disclosure.

In some implementations, apparatus 210 may also include a transceiver 216 coupled to processor 212. Transceiver 216 may be capable of wirelessly transmitting and receiving data, packets and frames. In some implementations, apparatus 220 may also include a transceiver 226 coupled to processor 222. Transceiver 226 may include a transceiver capable of wirelessly transmitting and receiving data, packets and frames.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a network device capable of communicating with each other using various proposed schemes in accordance with the present disclosure. For illustrative purposes and without limitation, a description of capabilities of apparatus 210, as an AP of a wireless network (e.g., Wi-Fi network based on an IEEE 802.11 standard), and apparatus 220, as a STA in the wireless network, is provided below. It is noteworthy that, although the example implementations described below are provided in the context of a UE, the same may be implemented in and performed by a base station. Thus, although the following description of example implementations pertains to apparatus 210 as a first network device (e.g., an AP or a STA), the same is also applicable to apparatus 220 as a second network device (e.g., as a STA or an AP).

Under various proposed schemes in accordance with the present disclosure, processor 212 of apparatus 210, as a first network device, may establish a wireless communication with apparatus 220, as a second network device in a wireless network (e.g., BSS 150). Additionally, processor 212 may detect a broadcast or multicast attack in the wireless network. Moreover, processor 212 may notify apparatus 220 of the attack with a pairwise key encrypted frame.

In some implementations, the wireless communication may be CCMP or TKIP enabled.

In some implementations, the wireless network may include a Wi-Fi BSS based on an IEEE 802.11 standard. Additionally, the first network device may be a station in the BSS, and the second network device may be an AP associated with the BSS.

In some implementations, the wireless network may include a Wi-Fi BSS based on an IEEE 802.11 standard. Moreover, the first network device may be an AP associated with the BSS, and the second network device may be a station in the BSS.

In some implementations, when the first network device is an AP, processor 212 may enable receiving of broadcast or multicast frames in the BSS with a BSSID equal to a MAC address of the AP.

In some implementations, when the first network device is an AP, processor 212 may trigger each station in the BSS to perform a group key rekey negotiation or a replay counter renew process such that the broadcast or multicast attack is prevented upon completion of the group key rekey negotiation or the replay counter renew process.

In some implementations, when the first network device is an AP, processor 212 may determine which station of a plurality of stations in the BSS as an attacking device that initiated the broadcast or multicast attack. Additionally, based on a result of the determining, processor 212 may disconnect the attacking device from the BSS and reject the attacking device from the BSS. In some implementations, in determining which station of the plurality of stations in the BSS as the attacking device that initiated the broadcast or multicast attack, processor 212 may determine which station of the plurality of stations in the BSS as the attacking device by using a group key rekey negotiation to uncover one or more stations of the plurality of stations as one or more attacking devices.

In some implementations, when the first network device is an AP, processor 212 may notify a network manager with a specific frame to indicate occurrence of the broadcast or multicast attack.

In some implementations, when the first network device is an AP, processor 212 may notify the network manager with a specific frame to indicate: (a) one or more stations in the BSS have been uncovered as one or more attacking devices that initiated the broadcast or multicast attack, and (b) that the one or more attacking devices have been disconnected.

In some implementations, the wireless network may include a group owner and a group client (GO/GC) peer-to-peer (P2P) wireless network, an independent basic service set (IBSS) wireless network based on an IEEE 802.11 standard, a Wireless Distribution System (WDS) and Mesh wireless network based on the IEEE 802.11 standard, or a Protected Management Frames (PMF) Broadcast Integrity Protocol (BIP) wireless network based on the IEEE 802.11 standard.

### Illustrative Processes

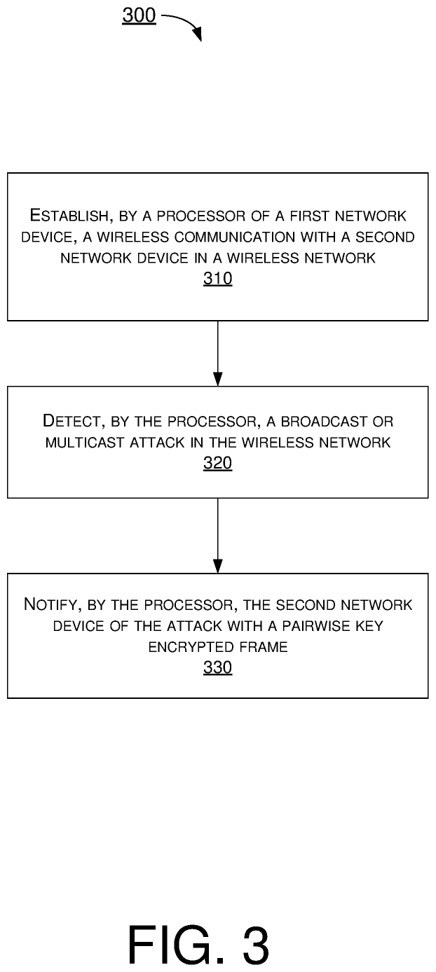

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to detection and prevention of broadcast and multicast packet attacking for uncovering and disconnecting attacker(s) in wireless communications. Process 300 may include one or more operations, actions, or functions as illustrated by one or more of blocks 310, 320 and 330. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. The blocks/sub-blocks of process 300 may be executed iteratively. Process 300 may be implemented by or in apparatus 210 and apparatus 220 as well as any variations thereof. Solely for illustrative purposes and without limiting the scope, process 300 is described below in the context of apparatus 210 as a first network device (e.g., an AP or a STA) and apparatus 220 as a second network device (e.g., a STA or an AP). Process 300 may begin at block 310.

At 310, process 300 may involve processor 212 of apparatus 210, as a first network device, establishing a wireless communication with apparatus 220, as a second network device in a wireless network (e.g., BSS 150). Process 300 may proceed from 310 to 320.

At 320, process 300 may involve processor 212 detecting a broadcast or multicast attack in the wireless network. Process 300 may proceed from 320 to 330.

At 330, process 300 may involve processor 212 notifying apparatus 220 of the attack with a pairwise key encrypted frame.

In some implementations, the wireless communication may be CCMP or TKIP enabled.

In some implementations, the wireless network may include a Wi-Fi BSS based on an IEEE 802.11 standard. Additionally, the first network device may be a station in the BSS, and the second network device may be an AP associated with the BSS.

In some implementations, the wireless network may include a Wi-Fi BSS based on an IEEE 802.11 standard. Moreover, the first network device may be an AP associated with the BSS, and the second network device may be a station in the BSS.

In some implementations, when the first network device is an AP, process 300 may involve processor 212 enabling receiving of broadcast or multicast frames in the BSS with a BSSID equal to a MAC address of the AP.

In some implementations, when the first network device is an AP, process 300 may involve processor 212 triggering each station in the BSS to perform a group key rekey negotiation or a replay counter renew process such that the broadcast or multicast attack is prevented upon completion of the group key rekey negotiation or the replay counter renew process.

In some implementations, when the first network device is an AP, process 300 may involve processor 212 determining which station of a plurality of stations in the BSS as an attacking device that initiated the broadcast or multicast attack. Additionally, based on a result of the determining, process 300 may involve processor 212 disconnecting the attacking device from the BSS and rejecting the attacking device from the BSS. In some implementations, in determining which station of the plurality of stations in the BSS as the attacking device that initiated the broadcast or multicast attack, process 300 may involve processor 212 determining which station of the plurality of stations in the BSS as the attacking device by using a group key rekey negotiation to uncover one or more stations of the plurality of stations as one or more attacking devices.

In some implementations, when the first network device is an AP, process 300 may involve processor 212 notifying a network manager with a specific frame to indicate occurrence of the broadcast or multicast attack.

In some implementations, when the first network device is an AP, process 300 may involve processor 212 notifying the network manager with a specific frame to indicate: (a) one or more stations in the BSS have been uncovered as one or more attacking devices that initiated the broadcast or multicast attack, and (b) that the one or more attacking devices have been disconnected.

In some implementations, the wireless network may include a GO/GC P2P wireless network, an IBSS wireless network based on an IEEE 802.11 standard, a WDS and Mesh wireless network based on the IEEE 802.11 standard, or a PMF BIP wireless network based on the IEEE 802.11 standard.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
establishing, by a processor of a first network device, a wireless communication with a second network device in a wireless network;
detecting, by the processor, a broadcast or multicast attack in the wireless network; and
notifying, by the processor, the second network device of the attack with a pairwise key encrypted frame.

2. The method of claim 1, wherein the wireless communication is Counter Mode Cipher Block Chaining Message Authentication Protocol (CCMP) or Temporal Key Integrity Protocol (TKIP) enabled.

3. The method of claim 1, wherein the wireless network comprises a Wi-Fi basic service set (BSS) based on an Institute of Electrical and Electronics Engineers (IEEE) 802.11 standard, wherein the first network device comprises a station in the BSS, and wherein the second network device comprises an access point (AP) associated with the BSS.

4. The method of claim 1, wherein the wireless network comprises a Wi-Fi basic service set (BSS) based on an Institute of Electrical and Electronics Engineers (IEEE) 802.11 standard, wherein the first network device comprises an access point (AP) associated with the BSS, and wherein the second network device comprises a station in the BSS.

5. The method of claim 4, further comprising:
enabling, by the processor, receiving of broadcast or multicast frames in the BSS with a basic service set identifier (BSSID) equal to a media access control (MAC) address of the AP.

6. The method of claim 4, further comprising:
triggering, by the processor, each station in the BSS to perform a group key rekey negotiation or a replay counter renew process such that the broadcast or multicast attack is prevented upon completion of the group key rekey negotiation or the replay counter renew process.

7. The method of claim 4, further comprising:
determining, by the processor, which station of a plurality of stations in the BSS as an attacking device that initiated the broadcast or multicast attack; and
based on a result of the determining:
disconnecting, by the processor, the attacking device from the BSS; and
rejecting, by the processor, the attacking device from the BSS.

8. The method of claim 7, wherein the determining of which station of the plurality of stations in the BSS as the attacking device that initiated the broadcast or multicast attack comprises determining which station of the plurality of stations in the BSS as the attacking device by using a group key rekey negotiation to uncover one or more stations of the plurality of stations as one or more attacking devices.

9. The method of claim 4, further comprising:
notifying, by the processor, a network manager with a specific frame to indicate occurrence of the broadcast or multicast attack.

10. The method of claim 4, further comprising:
notifying, by the processor, a network manager with a specific frame to indicate:
one or more stations in the BSS have been uncovered as one or more attacking devices that initiated the broadcast or multicast attack, and
that the one or more attacking devices have been disconnected.

11. The method of claim 1, wherein the wireless network comprises a group owner and a group client (GO/GC) peer-to-peer (P2P) wireless network, an independent basic service set (IBSS) wireless network based on an Institute of Electrical and Electronics Engineers (IEEE) 802.11 standard, a Wireless Distribution System (WDS) and Mesh wireless network based on the IEEE 802.11 standard, or a Protected Management Frames (PMF) Broadcast Integrity Protocol (BIP) wireless network based on the IEEE 802.11 standard.

12. An apparatus, comprising:
a transceiver capable of establishing, as a first network device, a wireless communication with a second network device in a wireless network; and
a processor coupled to the transceiver, the processor capable of:
detecting a broadcast or multicast attack in the wireless network; and
notifying the second network device of the attack with a pairwise key encrypted frame.

13. The apparatus of claim 12, wherein the wireless communication is Counter Mode Cipher Block Chaining Message Authentication Protocol (CCMP) or Temporal Key Integrity Protocol (TKIP) enabled.

14. The apparatus of claim 12, wherein the wireless network comprises a Wi-Fi basic service set (BSS) based on an Institute of Electrical and Electronics Engineers (IEEE) 802.11 standard, wherein the first network device comprises a station in the BSS, and wherein the second network device comprises an access point (AP) associated with the BSS.

15. The apparatus of claim 12, wherein the wireless network comprises a Wi-Fi basic service set (BSS) based on an Institute of Electrical and Electronics Engineers (IEEE) 802.11 standard, wherein the first network device comprises an access point (AP) associated with the BSS, and wherein the second network device comprises a station in the BSS.

16. The apparatus of claim 15, wherein the processor is further capable of:
enabling receiving of broadcast or multicast frames in the BSS with a basic service set identifier (BSSID) equal to a media access control (MAC) address of the AP.

17. The apparatus of claim 15, wherein the processor is further capable of:
triggering each station in the BSS to perform a group key rekey negotiation or a replay counter renew process such that the broadcast or multicast attack is prevented upon completion of the group key rekey negotiation or the replay counter renew process.

18. The apparatus of claim 15, wherein the processor is further capable of:
determining which station of a plurality of stations in the BSS as an attacking device that initiated the broadcast or multicast attack; and
based on a result of the determining:
disconnecting the attacking device from the BSS; and
rejecting the attacking device from the BSS,
wherein, in determining which station of the plurality of stations in the BSS as the attacking device that initiated the broadcast or multicast attack, the processor is capable of determining which station of the plurality of stations in the BSS as the attacking device by using a group key rekey negotiation to uncover one or more stations of the plurality of stations as one or more attacking devices.

19. The apparatus of claim 15, wherein the processor is further capable of either or both of:
notifying a network manager with a first frame to indicate occurrence of the broadcast or multicast attack; and
notifying the network manager with a second frame to indicate:
one or more stations in the BSS have been uncovered as one or more attacking devices that initiated the broadcast or multicast attack, and
that the one or more attacking devices have been disconnected.

20. The apparatus of claim 12, wherein the wireless network comprises a group owner and a group client (GO/GC) peer-to-peer (P2P) wireless network, an independent basic service set (IBSS) wireless network based on an Institute of Electrical and Electronics Engineers (IEEE) 802.11 standard, a Wireless Distribution System (WDS) and Mesh wireless network based on the IEEE 802.11 standard, or a Protected Management Frames (PMF) Broadcast Integrity Protocol (BIP) wireless network based on the IEEE 802.11 standard.
